(19) United States
(12) Patent Application Publication
(10) Pub. No.: US 2015/0381226 A1
(43) Pub. Date: Dec. 31, 2015

(54) PROTECTIVE COVER FOR ELECTRONIC DEVICES

(71) Applicant: Matthew Mogol, Sag Harbor, NY (US)

(72) Inventor: Matthew Mogol, Sag Harbor, NY (US)

(21) Appl. No.: 14/750,073

(22) Filed: Jun. 25, 2015

Related U.S. Application Data
(60) Provisional application No. 62/016,993, filed on Jun. 25, 2014.

(51) Int. Cl. H04B 1/3888; H04M 1/02

(52) U.S. Cl. CPC H04B 1/3888; H04M 1/0202; H04W 88/02

(57) ABSTRACT

The present invention discloses a protective cover for a mobile computing device, comprising a first side and a second side, with the first side in a first use configuration of the protective cover allowing access to a home button of the mobile computing device, and the second side in a second use configuration of the protective cover blocking access to the home button of the mobile computing device.

### CROSS-REFERENCE TO RELATED APPLICATIONS

This Application claims the benefit of priority of co-pending U.S. Utility Provisional Patent Application No. 62/016,993, filed 25 Jun. 2014, the entire disclosure of which is expressly incorporated by reference herein.

It should be noted that where a definition or use of a term in the incorporated patent application is inconsistent or contrary to the definition of that term provided herein, the definition of that term provided herein applies and the definition of that term in the incorporated patent application does not apply.

### BACKGROUND OF THE INVENTION

1. Field of the Invention

One or more embodiments of the present invention relate to protective cover (or case) for electronic devices such as mobile computing devices.

2. Description of Related Art

Conventional protective covers for electronic devices such as mobile computing devices are well known and have been in use for a number of years. Most do not prevent users such as children from accidentally performing unintended actions on the mobile computing device. There are conventional covers that do provide protection against accidental pressing or swiping of control buttons (e.g., the home button on an IPHONE® or an IPAD®), but they are complicated to manufacture, install, remove, and make it inconvenient for adult users to access the control buttons once they are installed.

Accordingly, in light of the current state of the art and the drawbacks to current protective covers mentioned above, a need exists for single protective cover that would prevent accidental performing of unintended actions on the mobile computing device in a first use configuration while allowing full access to all control mechanisms of the mobile computing device in a second use configuration.

### BRIEF SUMMARY OF THE INVENTION

A non-limiting, exemplary aspect of an embodiment of the present invention provides a protective cover for a mobile computing device, comprising:

a first side and a second side;

wherein: the first side in a first use configuration of the protective cover allows access to a control mechanism of the mobile computing device; and

the second side in a second use configuration of the protective cover blocks access to the control mechanism of the mobile computing device.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1D are a non-limiting, exemplary illustration of a protective cover and use thereof with a mobile computing device in accordance with one or more embodiments of the present invention;

FIGS. 2A and 2B are non-limiting, exemplary illustrations of the various views of the protective cover in first use configuration but without illustrating the mobile computing device in accordance with one or more embodiments of the present invention;

FIGS. 3A to 3D are non-limiting, exemplary illustrations of exemplary mating structures for detachably connecting a first piece and a second piece of protective cover in accordance with one or more embodiments of the present invention;

FIGS. 4A to 4E are non-limiting, exemplary illustrations of the various views of the protective cover in second use configuration but without illustrating the mobile computing device in accordance with one or more embodiments of the present invention; and

FIGS. 5A and 5B are non-limiting, exemplary illustrations of a protective cover in accordance with one or more embodiments of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention provide single protective cover that prevents accidental performing of unintended actions on the mobile computing device in a first use configuration while allowing full access to all control mechanisms of the mobile computing device in a second use configuration.

One or more embodiments of the present invention are directed to a case or protective cover that protects a mobile computing device and has the option to physically block access to the home button of a smartphone or a computer tablet. By blocking home screen access, consumers are able to place smartphones in pockets and handbags, to place tablet computers in briefcases and backpacks, and even allow toddlers to hold the devices knowing their smartphone and tablet are safe from unintentional activation.

An embodiment of the protective cover of the present invention is configured to physically block the home button of a smartphone or tablet from inadvertent engagement while providing the intended user to reconfigure the lower portion (or first piece) of the protective cover for access to the control button and/or touch screen. The protective cover is particularly useful to parents with young children (for example, ages six months to five years old) so as to keep the applications on the device from running (or to prevent termination of an active the desired application running or reverting the device to the home view); to block outgoing radio, cellular or other transmissions; and to maintain the data in the device from deletion or corruption. An alternative embodiment of the protective cover includes a battery pack. In addition, one or more embodiments of the protective cover are designed within the general boilerplate style of other cases to reduce costs.

One or more embodiments of the present invention are configured as a protective cover, having a second body section having a first end portion, a second end portion, a first wall, a second wall and a third wall such that the walls form a “U” shape. The protective cover further includes a first body section having a first end portion, a second end portion, a first wall, a second wall and a third wall such that the walls form a “U” shape. The first end portion of the first body section is configured to removably engage with the second end portion of the second body section, and the second face of the first body section has a solid surface from a first wall of the first body section to a second wall of the first body section. The protective cover may be further configured such that at least one wall of the second body section is formed with at least one hole, and at least one wall of the first body section is formed with at least one hole. The second body section and the first body section of the protective cover are configured to enclose a smartphone or a tablet computer.

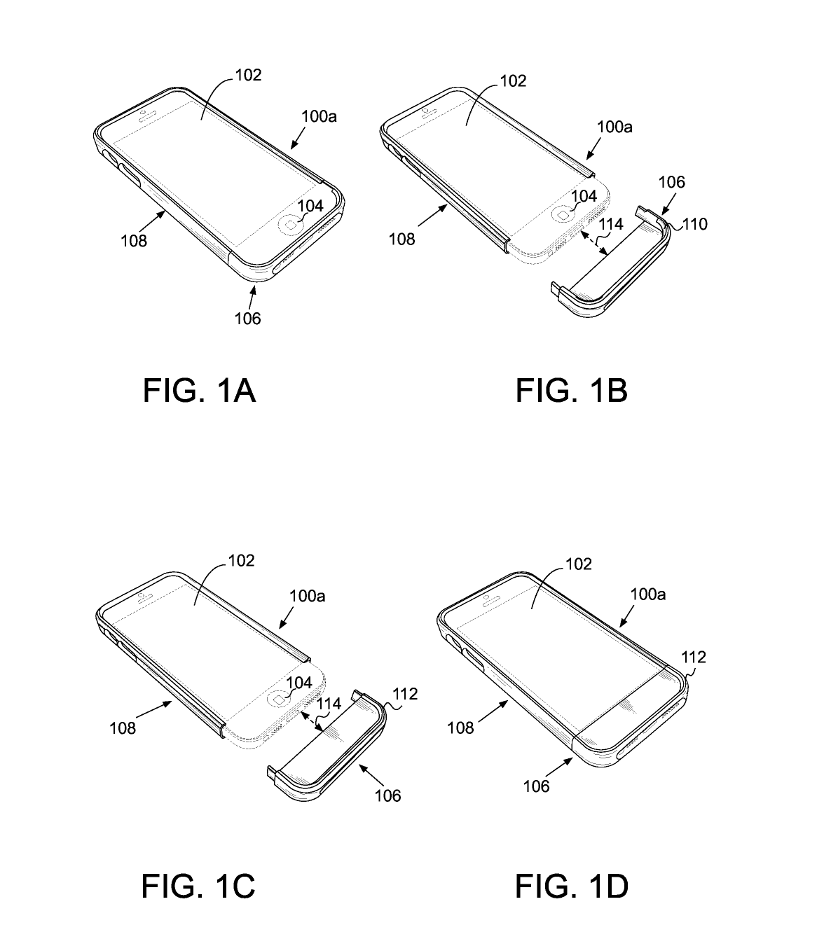

FIGS. 1A to 1D are a non-limiting, exemplary illustration of a protective cover and use thereof with a mobile computing device in accordance with one or more embodiments of the present invention. In particular, FIG. 1A is a non-limiting, exemplary illustration of protective cover 100 in first use configuration, enabling access to a control mechanism (home button) 104 of the mobile computing device 102. On the other hand, FIG. 1D is a non-limiting, exemplary illustration of protective cover 100 in second use configuration, blocking access to home button 104 of mobile computing device 102.

As illustrated in FIGS. 1A to 1D, protective cover 100 is comprised of a first piece 106 that is detachably coupled with a second piece 108. First piece 106 includes a first side 110 and a second side 112 (FIG. 1C), wherein first side 110 in a first use configuration of protective cover 100 (FIG. 1A) allows access to home button 104 of mobile computing device 102 to thereby allow actions to be performed on the mobile computing device 102. First piece 106 may easily be detached and separated from second piece 108 (as illustrated by arrow 114), flipped to second side 112 (FIG. 1C), and assembled by reattaching to second piece 108 (FIG. 1D) for second use configuration (FIG. 1D). That is, second side 112 of first piece 106 in the second use configuration (FIG. 1D) of protective cover 100 blocks access to home button 104 of mobile computing device 102, which prevents accidental, unintended actions to be performed on the mobile computing device 102.

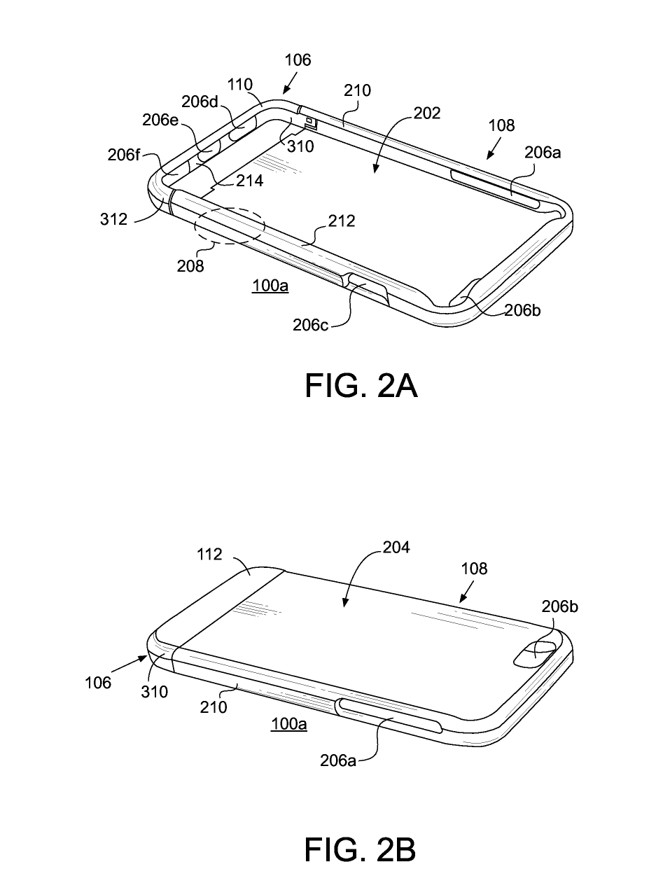

FIGS. 2A and 2B are non-limiting, exemplary illustrations of the various views of the protective cover in first use configuration but without illustrating the mobile computing device in accordance with one or more embodiments of the present invention. As illustrated in FIGS. 2A and 2B and indicated in FIGS. 1A to 1D, protective cover 100 is comprised of first piece 106 and a second piece 108 that when in first use configuration, operate to enable full access to all controls of the mobile computing device 102.

Protective cover 100 includes a front side 202 (FIG. 2A) that is open to enable access to the screen of mobile computing device 102, and a protective back cover 204 (FIG. 2B). The protective cover 100 includes one or more openings 206a to 206f to enable access to various control and input/output (I/O) ports of the mobile computing device 102. It should be noted that the location and the size of the exemplary illustrated openings 206a to 206f might vary commensurate with the type and model of mobile computing device 102 used. For example, a mobile computing device may have a charging port or some other port that when used with protective cover 100, may require an opening at location 208 indicated by dashed circular line in FIG. 2A, which would mean that protective cover 100 may include opening 208 at the indicated position instead of the illustrated opening 206c or in addition to any one or more of the openings 206a to 206f.

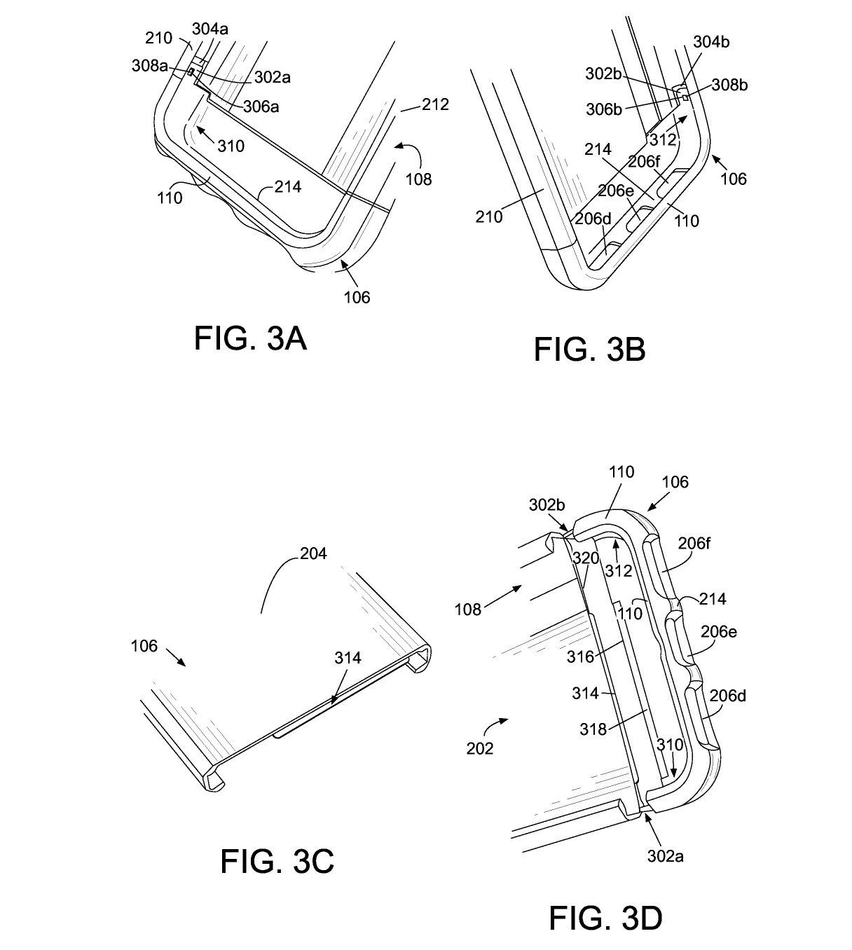

FIGS. 3A to 3D are non-limiting, exemplary illustrations of exemplary coupling structure for detachably connecting a first piece and a second piece of protective cover in accordance with one or more embodiments of the present invention. As illustrated and indicated above, protective cover 100 is comprised of first piece 106 that detachably couples with second piece 108. One of the first or second pieces 106 or 108 may include a set of projections/recesses that may detachably fit a set of recesses/projections of the other first or second piece 106 or 108 to secure the pieces together.

It should be noted that alternatively, first and second pieces 106 and 108 may frictionally fit mobile computing device 102 instead, without the use of projections/recesses. For example, pieces 106 and 108 may make a mechanical connection with mobile computing device 102 where they may snap or slip onto mobile computing device 102.

In this non-limiting, exemplary instance, first piece 106 includes a first side 110 that enables access to control mechanism (home button) 104, and a second side 112 that covers over the home button 104. First piece 106 further includes a third side 214 with one or more opening 206d to 206f to enable access to one or more ports of mobile computing device 102. It should be noted that third side 214 with one or more opening 206d to 206f enables access to one or more ports of mobile computing device 102 in both the first use configuration and the second use configuration of protective cover 100. As detailed below, additionally, first piece 106 further includes a lateral end (or sides) 310 and 312 that cover over parts of mobile computing device 102.

As indicated above, in this non-limiting, exemplary instance, first piece 106 includes a first lateral end 310 and a second lateral end 312, with each having projections 302a/b that extend from respective lateral ends 310 and 312 that may be inserted within respective recesses 304a/b at sides 210 and 212 of second piece 108. As further illustrated, the projections 302a/b may further include respective opening 306a/b that receive respective protuberances 308a/b that protrude from respective recesses 304a/b of sides 210 and 212 of second piece 108. As best illustrated in FIGS. 3C and 3D, first piece 106 may include an elongated recess 318 at side 316 that receives an elongated flange 314 at side 320 of second piece 108. As indicated above, alternatively, first and second pieces 106 and 108 may simply frictionally fit onto the mobile computing device instead, without the use of the illustrated connection mechanisms (e.g., projections/recesses).

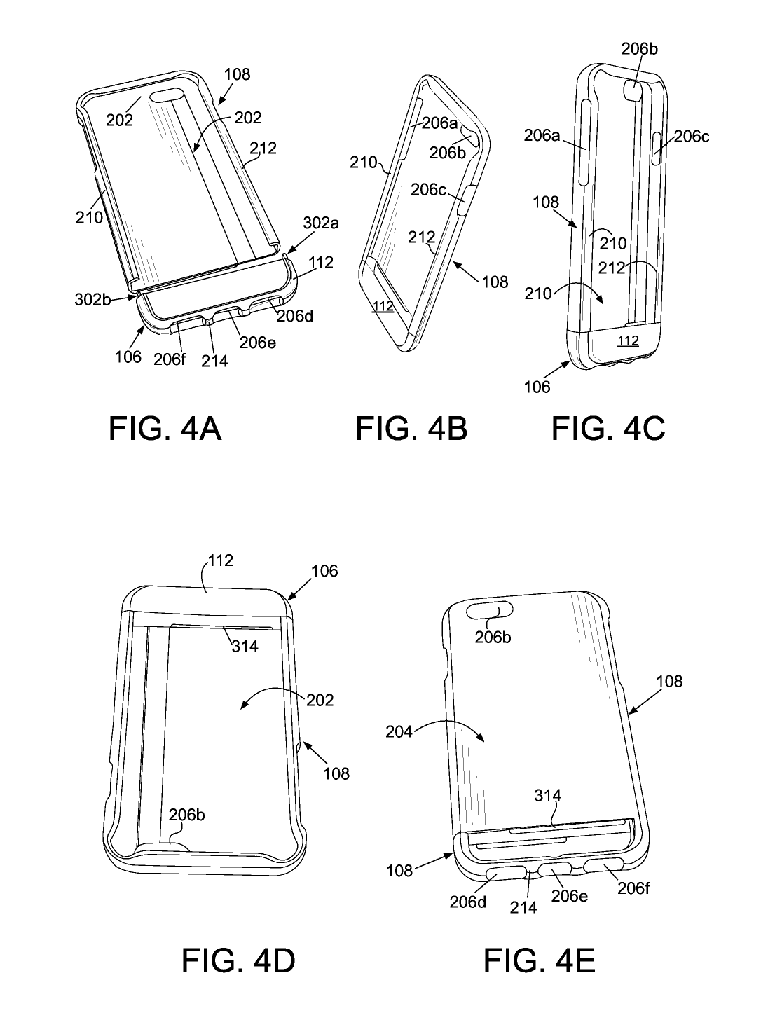

FIGS. 4A to 4E are non-limiting, exemplary illustrations of the various views of the protective cover in second use configuration but without illustrating the mobile computing device in accordance with one or more embodiments of the present invention. As illustrated in FIGS. 4A to 4E, protective cover 100 is comprised of first piece 106 and second piece 108 that in second use configuration, operate to block access to a main control mechanism (home button) 104 of mobile computing device 102. Protective cover 100 may operate in second use configuration by simply detaching first piece 106 from second piece 108, flipping over first piece 106 from its first side 110 to its second side 112 (as indicated in FIG. 4A), and reattaching the inverted first piece 106 with second piece 108 (FIGS. 4B to 4D). If first and second piece 106 and 108 are simply friction-fit mounted onto mobile computing device 102, protective cover 100 may operate in second use configuration by simply detaching first piece 106 from mobile computer device 102, flipping over first piece 106 from its first side 110 to its second side 112 (as indicated in FIG. 4A), and remounting the inverted first piece 106 onto mobile computing device 102 (FIGS. 4B to 4D). Accordingly, partial operation of mobile computing device 102 is allowed when first piece 106 is detachably associated with second piece 108 in second use configuration of first piece 106. Second use configuration of protective cover 100 includes covering over control mechanism (home button) 104 by second side 112. Accordingly, first piece 106 detachably associates with second piece 108 in both the first use configuration of protective cover 100 (FIGS. 1A, 2A and 2B) and the second use configuration of protective cover 100 (FIGS. 1D, and 4A to 4D). As illustrated, second piece 108 is adapted to detachably associate with first piece 106 in first use configuration of the first piece 106 or second use configuration of the first piece 106. Further, as indicated above, third side 214 of first piece 106 with one or more opening 206d to 206f enables access to one or more ports of mobile computing device 102 in both the first use configuration and the second use configuration of protective cover 100. It should be noted that second piece 108 may also be flipped and used in reverse, where protective back cover 204 covers over the touch screen of mobile computing device 102.

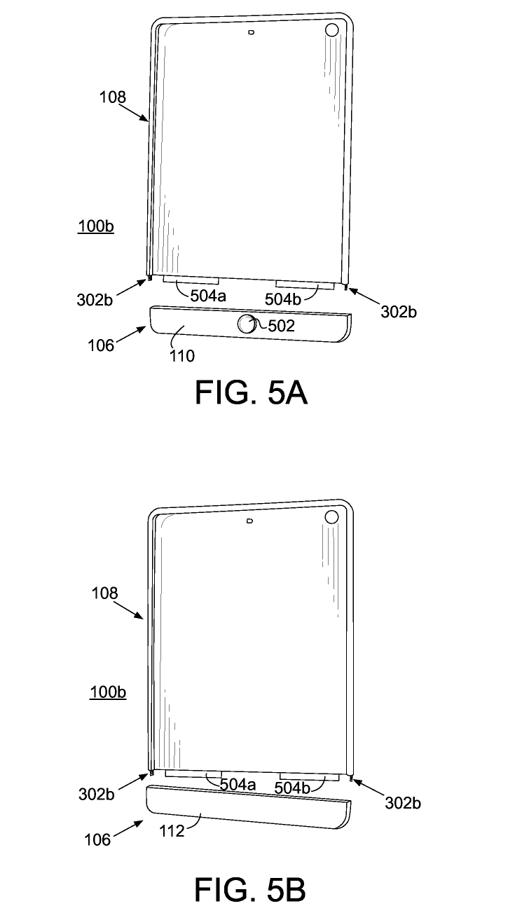

FIGS. 5A and 5B are non-limiting, exemplary illustrations of a protective cover in accordance with one or more embodiments of the present invention. Protective cover 100b illustrated in FIGS. 5A and 5B includes similar corresponding or equivalent components, parts, sections, interconnections, functional, operational, and or cooperative relationships as the device 100a that is shown in FIGS. 1A to 4E, and described above. Therefore, for the sake of brevity, clarity, convenience, and to avoid duplication, the general description of FIGS. 5A and 5B will not repeat every corresponding or equivalent component, parts, sections, interconnections, functional, operational, and or cooperative relationships that has already been described above in relation to protective cover 100a that is shown in FIGS. 1A to 4E.

As illustrated, protective cover 100b includes first piece 106 that has a first side 110 is fully covered with the exception of an opening (or hole) 502 that allows access to control mechanism (home button) 104 of mobile computing device 102 in the first use configuration (FIG. 5A) of protective cover 100b. First use configuration of protective cover 100b includes alignment of opening 502 of first side 110 over control mechanism 104. As illustrated in FIG. 5B, in second use configuration of protective cover 100b, second side 112 has no opening and therefore, covers over home button 104. Further illustrated is that in this non-limiting, exemplary embodiment, it is second piece 108 that includes projections 302a/b, with first piece 106 including structures shown on second piece 108 of first embodiment (FIGS. 1A to 4E). Further, in this non-limiting, exemplary embodiment, second piece 108 includes two elongated flanges 504a and 504b, with first piece 106 comprising respective recesses (shown in FIG. 3D) for receiving elongated flanges 504a and 504b. Accordingly, protective cover 100 may easily be adapted to accommodate most types, models, and sizes of mobile computing device 102.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. For example, the protective cover may be made from various materials, for example, metals, plastics, shock resistant polymers such as polyurethane, composites or from any other materials that can provide the necessary shape, form and features that make them suitable for the purposes of this invention. As yet another example, other well known mechanism for detachably connecting the two pieces may be used and hence, the details provided should not be limiting. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A protective cover for a mobile computing device, comprising:
a first side and a second side;
wherein: the first side in a first use configuration of the protective cover allows access to a control mechanism of the mobile computing device; and
the second side in a second use configuration of the protective cover blocks access to the control mechanism of the mobile computing device.

2. The protective cover for a mobile computing device as set forth in claim 1, wherein:
3. the first side includes an opening that allows access to the control mechanism of the mobile computing device in the first use configuration of the protective cover.

3. The protective cover for a mobile computing device as set forth in claim 2, wherein:
the first use configuration of the protective cover includes alignment of the opening of the first side over the control mechanism.

4. The protective cover for a mobile computing device as set forth in claim 1, wherein:
the second use configuration of the protective cover includes covering over the control mechanism by the second side.

5. The protective cover for a mobile computing device as set forth in claim 1, further comprising:
a third side with one or more opening to enable access to one or more ports of the mobile computing device.

6. The protective cover for a mobile computing device as set forth in claim 1, further comprising:
a first lateral end and a second lateral end that cover over parts of the mobile computing device.

7. A protective cover for a mobile computing device, comprising:
a first side that includes an opening that when aligned with a control mechanism of the mobile computing device in first use configuration of the protective cover allows access to the control mechanism;
a second side that has no opening and covers over the control mechanism of the mobile computing device in a second use configuration of the protective cover;
a third side with one or more opening to enable access to one or more ports of the mobile computing device in both the first use configuration and the second use configuration of the protective cover; and
lateral sides that cover over lateral parts of the mobile computing device in both the first use configuration and the second use configuration of the protective cover.

8. A protective cover for a mobile computing device, comprising:
a first piece and a second piece;
the first piece includes:
a first side and a second side;
wherein: the first side in a first use configuration of the protective cover allows access to a control mechanism of the mobile computing device; and
the second side in a second use configuration of the protective cover blocks access to the control mechanism of the mobile computing device.

9. The protective cover for a mobile computing device as set forth in claim 8, wherein:
the first piece detachably connects with the second piece in both the first use configuration of the protective cover and the second use configuration of the protective cover.

10. The protective cover for a mobile computing device as set forth in claim 8, wherein:
one of the first or second piece includes a set of projections that detachably fit a set of recesses of the other first or second piece.

11. The protective cover for a mobile computing device as set forth in claim 8, wherein:
the second piece has only a single use configuration that is adapted to detachably connect with the first piece in first use configuration of the first piece or second use configuration of the first piece.

12. The protective cover for a mobile computing device as set forth in claim 8, wherein:
the second piece includes one or more openings that allows access to secondary control mechanisms of the mobile computing device when installed.

13. The protective cover for a mobile computing device as set forth in claim 8, wherein:
unhindered, proper operation of the mobile computing device is allowed when the first piece is detachably connected with the second piece in the first use configuration of the first piece.

14. The protective cover for a mobile computing device as set forth in claim 8, wherein:
control mechanism of the mobile computing device is covered over when the first piece is detachably connected with the second piece in the second use configuration of the first piece.

15. The protective cover for a mobile computing device as set forth in claim 8, wherein:
4. the first side includes an opening that allows access to the control mechanism of the mobile computing device in the first use configuration of the protective cover.

16. The protective cover for a mobile computing device as set forth in claim 8, wherein:
the first use configuration of the protective cover includes alignment of the opening of the first side over the control mechanism.

17. The protective cover for a mobile computing device as set forth in claim 8, wherein:
the second use configuration of the protective cover includes covering over the control mechanism by the second side.

18. The protective cover for a mobile computing device as set forth in claim 8, wherein:
the first piece further includes:
a third side with one or more opening to enable access to one or more ports of the mobile computing device.

19. The protective cover for a mobile computing device as set forth in claim 8, wherein:
the first piece further includes:
a first lateral end and a second lateral end that cover over parts of the mobile computing device.

20. The protective cover for a mobile computing device as set forth in claim 8, wherein:
the first piece further includes:
a third side with one or more opening to enable access to one or more ports of the mobile computing device in both the first use configuration and the second use configuration of the protective cover.

21. The protective cover for a mobile computing device as set forth in claim 8, wherein:
the first piece and the second piece are mounted and frictionally secured onto the mobile computing device.
